(19) United States
(12) Patent Application Publication
(10) Pub. No.: US 2012/0233813 A1
(43) Pub. Date: Sep. 20, 2012

(54) DOOR CHECKER UNIT OF MOTOR VEHICLE

(75) Inventors: Yoshiharu SETTSU, Yokohama-shi (JP); Toshihisa NISHIJO, Yokohama-shi (JP)

(73) Assignee: MITSUI KINZOKU ACT CORPORATION

(21) Appl. No.: 13/417,795

(22) Filed: Mar. 12, 2012

(30) Foreign Application Priority Data
Mar. 17, 2011 (JP) 2011-059237

(51) Int. Cl. E05F 5/00

(52) U.S. Cl. 16/82

(57) ABSTRACT

A door checker unit of a motor vehicle comprises a check link including a base end connected to a vehicle body, an elongate portion that extends from the base end and is formed with a waved detent portion and a head-like stopper that is integrally formed on a leading end of the elongate portion; and a check box connected to a vehicle door, the check box including upper and lower press shoes for putting therebetween the check link, each of the upper and lower press shoes having a projected guide wall, wherein the waved detent portion has upper and lower waved detent surfaces provided on the check link, the guide walls of the press shoes put therebetween the check link; and a width of the base end is substantially the same as that of the waved detent portion of the check link.

### BACKGROUND OF THE INVENTION

1. Field of the Invention

The present invention relates to a door checker unit of a motor vehicle, which provides open/close pivoting movement of a vehicle door with a checking force for retaining the door at a half-open position and a full open position.

2. Description of Related Art

Hitherto, various types of door checker units have been proposed and put into practical use in the field of wheeled motor vehicles.

One of the door checker units of such known type is disclosed in U.S. Pat. No. 7,383,614.

The door checker unit of the Patent generally comprises a check link that has a base end fixed to a vehicle body side bracket and an elongate leading portion retractably led into a vehicle door from a guide opening formed in the door, and a check box that is installed in the door and has upper and lower press shoes for holding a detent surface portion of the check link with the aid of biasing members. The elongate leading portion of the check link is provided at a leading end thereof with a head-like stopper.

When the door is swung from a closed position to a so-called half-open position, the two press shoes of the check box slide on upper and lower surfaces of the check link and come to the detent surface portion of the check link. Upon this, the two press shoes tightly hold therebetween the detent surface portion of the check link with the aid of the biasing members thereby to retain the door at the half-open position. When the door is further swung outward, the two press shoes of the check box are brought into abutment with the head-like stopper of the check link. Upon this, further outward swing of the door is suppressed. That is, the full-open position of the door is retained.

### SUMMARY OF THE INVENTION

In the above-mentioned known door checker unit, due to its inherent construction caused by the provision of the head-like stopper that is integral with the check link, it is necessary to make a manual work for inserting the base end of the check link between the two press shoes of the check box before the base end is connected to the vehicle body side bracket.

However, hitherto, the manual work for inserting the base end of the check link between the two press shoes has been complicated and troublesome because a dimensional relation between the base end of the check link and each of the two press shoes has been given little thought. Actually, in the door checker unit of the above-mentioned Patent, the base end of the check link is enlarged in width as compared with the other portion of the check link. In fact, it has often occurred that due to the enlarged width, the base end of the check link becomes jammed up in the check box during passing between the two press shoes. Of course, such jamming of the base end of the check link deteriorates the workability of assembling the door checker unit.

It is therefore an object of the present invention to provide a door checker unit of a motor vehicle, which is free of the above-mentioned drawback.

According to the present invention, there is provided a door checker unit of a motor vehicle, wherein upper and lower press shoes are arranged to insert therebetween a check link. The check link comprises a base end that is to be connected to a vehicle body, an elongate portion that extends from the base end and is formed with a waved detent potion and a head-like stopper that is integrally formed on a leading end of the elongate portion, in which the waved detent portion consists of upper and lower waved surfaces provided on the check link and the width of the base end is substantially the same as that of the elongate portion. Each of the press shoes is formed with a projected sliding portion that faces an upper or lower surface of the check link and a guide wall that projects downward or upward from one end of the projected sliding portion and the upper and lower press shoes are so arranged that the projected sliding portions thereof slidably put therebetween the check link in a vertical direction and the guide walls slidably put therebetween the check link in a lateral direction.

In accordance with a first aspect of the present invention, there is provided a door checker unit of a motor vehicle, which comprises a check link including a base end adapted to be connected to one of a vehicle body and a vehicle door, an elongate portion that extends from the base end and is formed with a waved detent portion and a head-like stopper that is integrally formed on a leading end of the elongate portion; and a check box adapted to be connected to the other one of the vehicle body and the vehicle door, the check box including upper and lower press shoes for putting therebetween the check link in a vertical direction and biasing members for biasing the upper and lower press shoes toward the check link, each of the upper and lower press shoes being formed with a projected guide wall, wherein the waved detent portion of the check link consists of upper and lower waved detent surfaces provided on the check link; wherein the guide walls of the upper and lower press shoes put therebetween the check link in a lateral direction; and wherein a width of the base end of the check link is substantially the same as that of the waved detent portion of the check link.

In accordance with a second aspect of the present invention, there is provided a door checker unit of a motor vehicle, which comprises a case adapted to connect to a door and having an opening formed therethrough; a check link having a base end adapted to connect to a vehicle body and extending through the opening of the case to an end thereof where an head-like stopper is integrally formed; upper and lower press shoes movably installed in the case in a manner to put therebetween the check link; and upper and lower biasing members installed in the case in a manner to bias the upper and lower press shoes toward the check link, wherein the check link comprises an elongate metal plate and a molded plastic cover that covers the metal plate to constitute upper and lower waved detent surfaces of the molded plastic on the metal plate, the base end of the check link having a boss portion whose width is substantially the same as a width of the check link at a portion where the upper and lower waved detent surfaces are provided, and a thickness of the boss portion being larger than that of the check link at a portion placed between the boss portion and each of the upper and lower waved detent surfaces, wherein each of the upper and lower press shoes is formed with a projected sliding portion that faces an upper or lower surface of the check link and a guide wall that projects downward or upward from one end of the projected sliding portion, and wherein the upper and lower press shoes are so arranged that the projected sliding portions of the press shoes slidably put therebetween the check link in a vertical direction and the guide walls slidably put therebetween the check link in a lateral direction.

In accordance with a third aspect of the present invention, there is provided a door checker unit of a motor vehicle, which comprises a case adapted to connect to a door and having an opening formed therethrough; a check link having a base end adapted to connect to a vehicle body and extending through the opening of the case to a leading end thereof where a head-like stopper is integrally provided; upper and lower press shoes movably installed in the case in a manner to put therebetween the check link; and upper and lower biasing members installed in the case in a manner to bias the upper and lower press shoes toward the check link, wherein the check link comprises an elongate metal plate and a molded plastic cover that covers the metal plate to constitute upper and lower waved detent surfaces of the molded plastic on the metal plate, the base end of the check link having a thicker boss portion whose width is substantially the same as a width of the check link at a portion where the upper and lower waved detent surfaces are provided, and a thickness of the thicker boss portion being greater than that of the check link at a portion placed between the boss portion and each of the upper and lower waved detent surfaces, wherein each of the upper and lower press shoes is formed with a projected sliding portion that faces an upper or lower surface of the check link, a guide wall that projects downward or upward from one end of the projected sliding portion and a guide groove that is depressed from the other end of the projected sliding portion, and wherein the upper and lower press shoes are so arranged that the projected sliding portions of the press shoes slidably put therebetween the check link in a vertical direction and the guide walls slidably put therebetween the check link in a lateral direction and slidably put in the guide grooves of each partner's press shoe.

### BRIEF DESCRIPTION OF THE DRAWINGS

Other objects and advantages of the present invention will become apparent from the following description when taken in conjunction with the accompanying drawings, in which:

FIG. 1 is a perspective view of a motor vehicle at a portion where a door checker unit of the present invention is practically employed for retaining a vehicle door at a given open position;

FIG. 2 is a plan view of the door checker unit of a first embodiment of the present invention;

FIG. 3 is a sectional view taken along the line of FIG. 2;

FIG. 4 is a view similar to FIG. 3, but showing a condition wherein the door takes its full-open position;

FIG. 5 is a side view of a check link that is an element of the door checker unit of the first embodiment;

FIG. 6 is an enlarged perspective view of paired press shoes that are used in the door checker unit of the first embodiment;

FIG. 7 is an enlarged sectional view taken along the line VII-VII of FIG. 2;

FIG. 8 is an enlarged vertically sectional view of the door checker unit of the first embodiment showing a condition wherein a boss end portion of the check link is just inserted between the paired press shoes;

FIG. 9 is a view similar to FIG. 8, but showing a condition wherein the boss end portion of the check link is deeply inserted between the paired press shoes;

FIG. 10 is a vertically sectional view taken along the line X-X of FIG. 9;

FIG. 11 is a horizontally sectional view taken along the line XI-XI of FIG. 10;

FIG. 12 is an enlarged vertically sectional view of the boss end portion of the check link;

FIG. 13 is an enlarged perspective view of paired press shoes that are employed in a door checker unit of a second embodiment of the present invention;

FIG. 14 is a view similar to FIG. 7, but showing a check box used in the door checker unit of the second embodiment; and

FIG. 15 is a view similar to FIG. 10, but showing the check box used in the door checker unit of the second embodiment.

### DETAILED DESCRIPTION OF THE INVENTION

In the following, a door checker unit of the present invention will be described in detail with reference to the accompanying drawings.

For ease of understanding, the following explanation will be directed to a door checker unit that is practically applied to a front-right door “D” of a motor vehicle, which is pivoted forward when taking an open position and pivoted rearward when taking a close position.

Furthermore, in the following description, various directional terms, such as, right, left, upper, lower, rightward and the like are used. It is however to be noted that the terms are to be understood with respect to only a drawing or drawings on which a corresponding element, part or portion is shown.

First, a door checker unit 1 of a first embodiment will be described in detail with reference to the accompanying drawings.

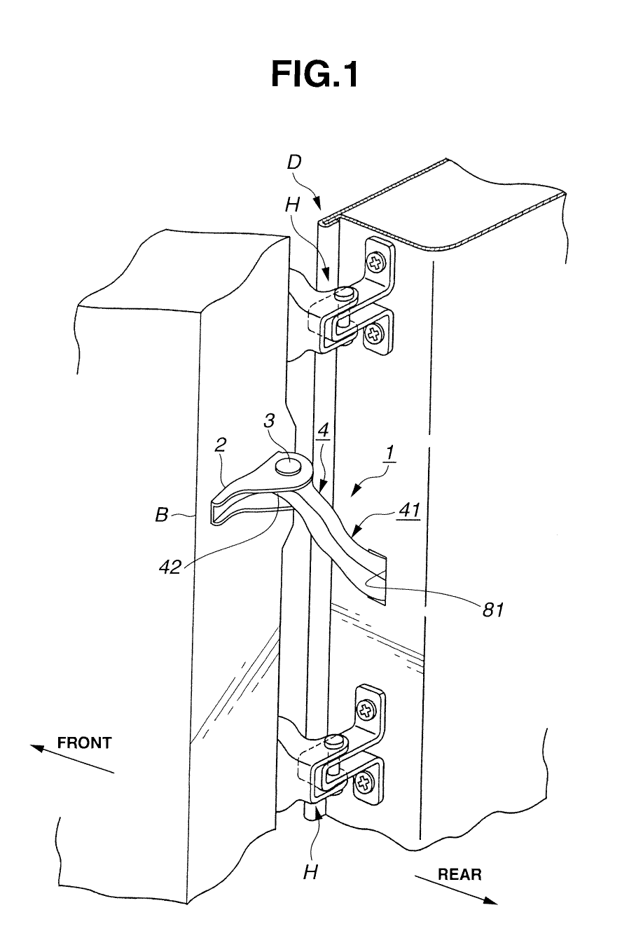

Referring to FIG. 1, denoted by B and D are respectively a vehicle body and a vehicle door. The vehicle door D shown in this drawing takes an open position.

As shown in FIG. 1, the vehicle door D is pivotally connected to the vehicle body B through upper and lower hinges H and H to horizontally swing between a full-close position and a full-open position.

Each hinge H comprises a body side bracket (no numeral) secured to the vehicle body B, a door side bracket (no numeral) secured to the vehicle door D and a pivot pin (no numeral) through which the body side bracket and the door side brake are pivotally connected, as shown in FIG. 1.

It is thus to be noted that for taking the full-open and full-close positions, the vehicle door D is allowed to swing while taking a given curved track.

The door checker unit 1 functions to provide the open/close swing movement of the vehicle door D with a checking force to retain the door D at a half-open position and the full-open position (or opening limit).

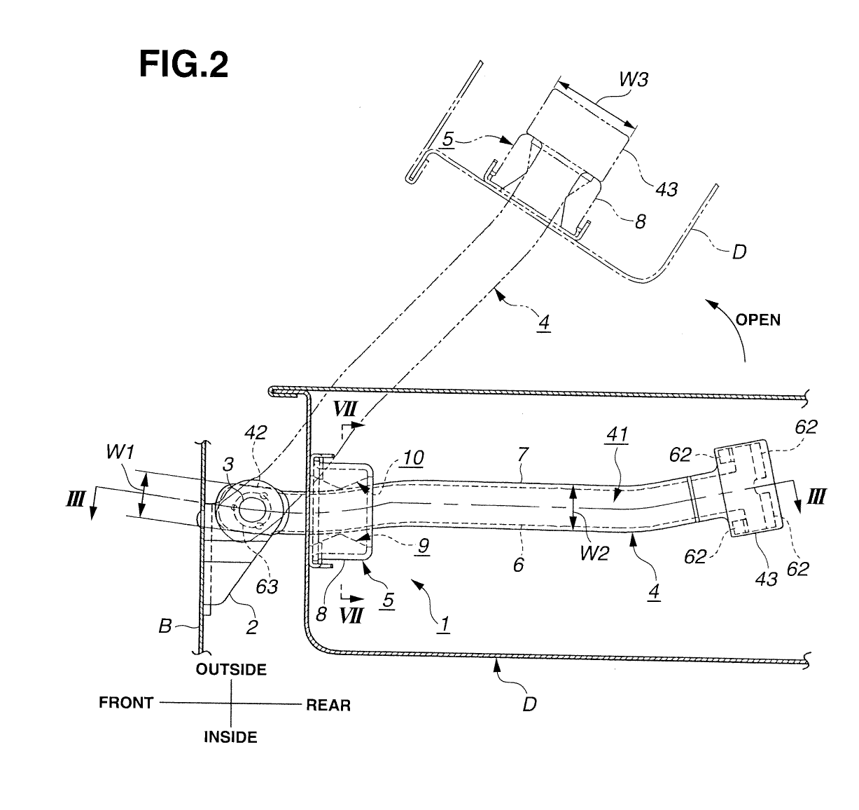

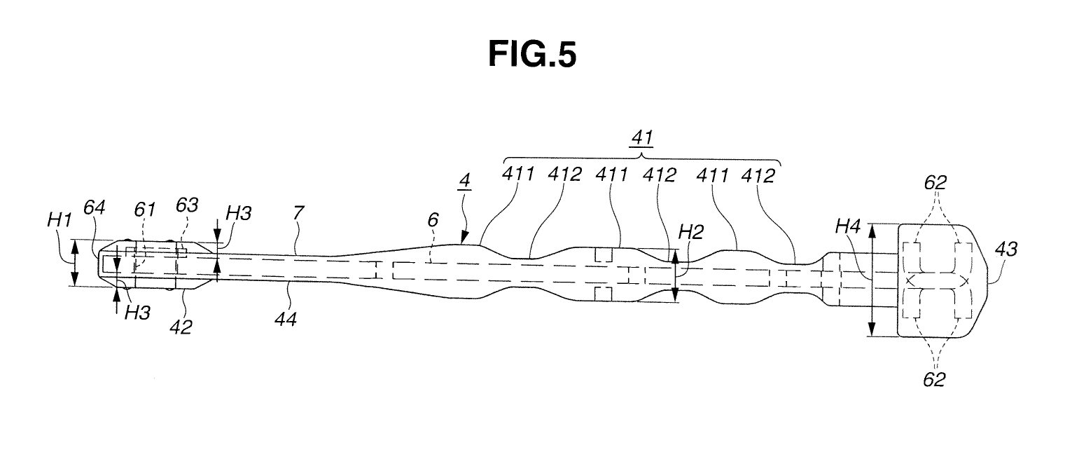

As is seen from FIGS. 1 and 2, the door checker unit 1 comprises a bracket 2 that is fixed to the vehicle body B, a check link 4 that has a perforated base end 42 (see FIG. 5) pivotally connected through a vertically extending pivot pin 3 to the bracket 2 and has a leading portion inserted into the vehicle door D from a rectangular guide opening 81 formed in a front end wall of the vehicle door D, and a check box 5 that is installed in the vehicle door D and receives therein a part of the leading portion of the check link 4.

As is seen from FIG. 2, the leading portion of the check link 4, which is inserted into the vehicle door D, is associated with the check box 5 that is fixed to the front end wall of the vehicle door D.

The check link 4 is integrally formed at its leading end with a head-like stopper 43.

As will be understood from FIG. 2, when the vehicle door D is pivoted in an opening direction (viz., the direction denoted by “open”) from the full-close position, the check box 5 is moved away together with the door D from the vehicle body B while running on the check link 4 toward the head-like stopper 43 formed on the leading end of the check link 4.

When, due to further opening movement of the door D, the check box 5 is moved to a position to contact with the head-like stopper 43 as shown by a dot-dash line, further opening swing of the door D is stopped.

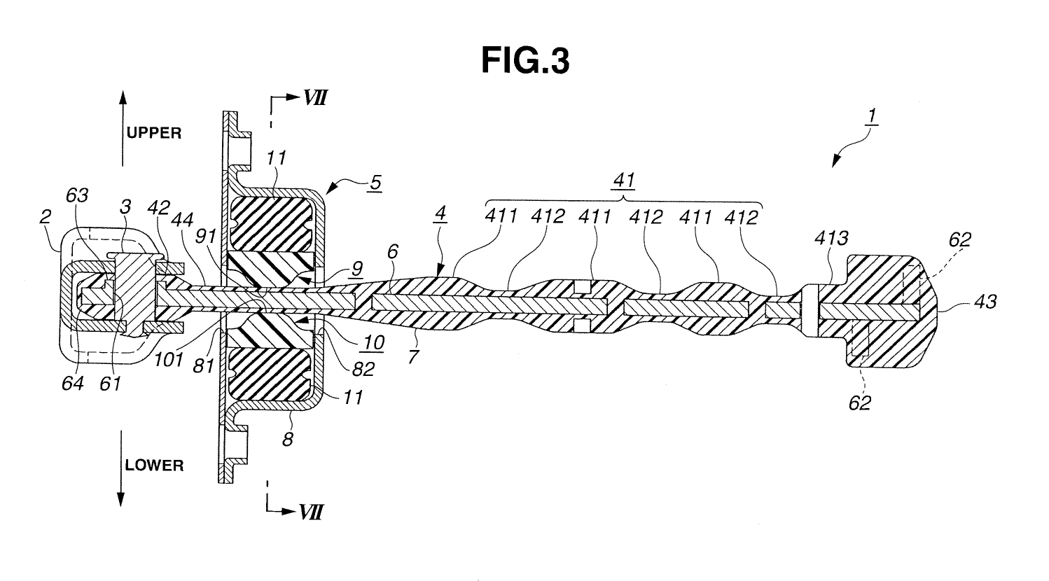

As is seen from FIG. 3, the check link 4 is an elongate metal plate 6 covered with a molded plastic cover 7.

Actually, the check link 4 is produced by way of injection molding using a split-cavity mold including upper and lower molding dies. That is, at first, the elongate metal plate 6 is set in the split-cavity mold and then, a molten material of the plastic cover 7 is injected into the split-cavity mold. When the maternal is cured and thus hardened to a sufficient level, the upper molding die is removed from the lower molding die for releasing a produced check link 4 from the mold.

As shown in FIG. 3, the metal plate 6 is formed with openings (no numerals) into which the molten material of the plastic cover 7 run to assure the bonding of the plastic cover 7 to the metal plate 6.

As shown in FIG. 3, the metal plate 6 is formed at its base end portion with a circular opening 61 through which the above-mentioned pivot pin 3 passes, and the metal plate 6 is formed at its leading end with four bent branches 62 that project in various directions. Due to provision of the bent branches 62, the head-like stopper 43 made of the plastic is tightly secured to the metal plate 6. The circular opening 61 is formed by way of a barring method thereby to provide the circular opening 61 with an annular ridge 63.

As shown, the molded plastic cover 7 on the metal plate 6 is provided with upper and lower waved detent surfaces 41 each including three roundly projected portions 411 and three roundly depressed portions 412 which are alternately arranged as shown.

The plastic cover 7 is formed at its base end with a perforated boss portion 42 that is coaxial with the above-mentioned circular opening 61 of the metal plate 6 for passing therethrough the pivot pin 3.

The head-like stopper 43 of the check link 4 has a neck portion 413 whose size is substantially the same as the projected portions 411.

As is seen from FIG. 3, the perforated boss portion 42 of the plastic cover 7 covers the base end of the metal plate 6 except the portion where the circular opening 61 is formed.

As is seen from FIGS. 2 and 11, a lateral size (or width) W1 of the perforated boss portion 42 is substantially the same as a lateral size (or width) W2 of the molded plastic cover 7 at a portion where the upper and lower waved detent surfaces 41 are provided, and as is seen from FIG. 5, the thickness H1 of the perforated boss portion 42 (viz., the size of the boss portion 42 in the axial direction of the pivot pin 3) is substantially the same as the thickness H2 of the projected portions 411.

As has been mentioned hereinabove, the perforated boss portion 42 is produced by way of injection molding. With such injection molding, the perforated boss portion 42 is shaped to surround the circular opening 61 of the metal plate 6.

Thus, a satisfied mechanical strength is obtained by the perforated boss portion 42 without enlarging the lateral size W1 of the boss portion 42 relative to the lateral size W2 of the detent surface 41 of the plastic cover 7.

As is seen from FIG. 12, on an inner cylindrical surface of the circular opening 61, there are put a plurality of projected portions 71 which are made of the material of the plastic cover 7. These projected portions 71 are produced by way of the above-mentioned injection molding technique using the split-cavity mold. Each projected portion 71 has a generally H-shape, as shown. Due to provision of such projected portions 71, the pivot turning of the perforated boss portion 42 around the pivot pin 3 can be smoothly made.

As is seen from FIG. 5, the base end portion of the check link 4 has a tapered end 64 that is directed in a leftward direction in the drawing.

Due to provision of such tapered end 64, insertion of the perforated boss portion 42 of the check link 4 between the two press shoes 9 and 10 of the check box 5 at the time of preassembling the door checker unit 1 can be quickly and smoothly made, as will be described in detail hereinafter.

As has been mentioned hereinabove, the head-like stopper 43 of the check link 4 is produced by entirely covering the bent branches 62 of the metal plate 6 with the molten material of the plastic cover 7.

As is seen from FIG. 2, a lateral size W3 of the head-like stopper 43 is larger than the lateral size W2 of the detent surface 41 of the molded plastic cover 7, and as is seen from FIG. 5, a thickness H4 of the stopper 43 is larger than the thickness H2 of each projected portion 411.

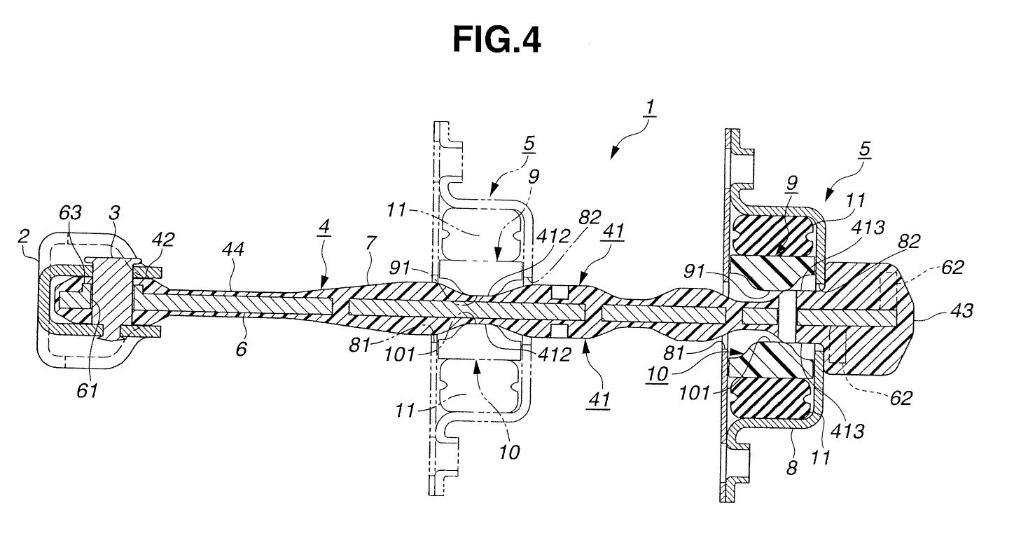

As will be described in detail hereinafter, when the vehicle door D is in the full-open position, the door checker unit 1 takes a condition as shown in FIG. 4.

In this condition, the rear surface of the case 8 of the check box 5 abuts against a flat front surface of the head-like stopper 43 thereby suppressing the vehicle door D from making further opening movement. Due to provision of the bent branches 62 of the metal plate 6 that are embedded in the head-like stopper 43, the stopper 43 exhibits a satisfied counter force against the door opening force.

In the following, the detail of the check box 5 will be described with the aid of the drawings.

As is seen from FIGS. 2 and 3, the check box 5 comprises a case 8 that is installed in the vehicle door D and secured to a front end wall of the vehicle door D in a manner to face the rectangular guide opening 81 of the front end wall.

As will be understood from FIG. 3, for securing the case 8 to the front end wall of the door D, connecting bolts (not shown) are used which pass through bolt openings (no numeral) formed in a flange portion of the case 8.

The case 8 is formed at its bottom wall with a rectangular opening 82 through which the check link 4 passes. More specifically, under operation of the door checker unit 1, the check link 4 is permitted to run through the two rectangular openings 81 and 82.

Upper and lower press shoes 9 and 10 are vertically movably installed in the case 8 in such a manner as to put therebetween the check link 4. More specifically, the upper and lower press shoes 9 and 10 are arranged to respectively contact with the upper and lower surfaces of the check link 4 that include the upper and lower waved detent surfaces 41.

Upper and lower elastic bodies 11 are installed in the case 8 in a manner to respectively bias the upper and lower press shoes 9 and 10 toward the check link 4. The elastic bodies 11 are made of rubber or the like. If desired, in place of the elastic bodies 11, a pair of coil springs may be employed.

As is seen from FIG. 9, each press shoe 9 or 10 is formed with a roundly projected sliding portion 91 or 101 that slidably contacts with the upper or lower surface of the check link 4.

Due to provision of the roundly projected sliding portions 91 and 101, insertion of the perforated boss portion 42 of the check link 4 between the two press shoes 9 and 10 at the time of preassembling the door checker unit 1 can be quickly and smoothly carried out. More specifically, a mutually compensating mating between each of the roundly projected sliding portions 91 and 101 of the press shoes 9 and 10 and the tapered end 64 of the perforated boss portion 42 promotes or facilitates such insertion of the perforated boss portion 42 between the two press shoes 9 and 10.

In the following, the upper and lower press shoes 9 and 10 will be described in detail.

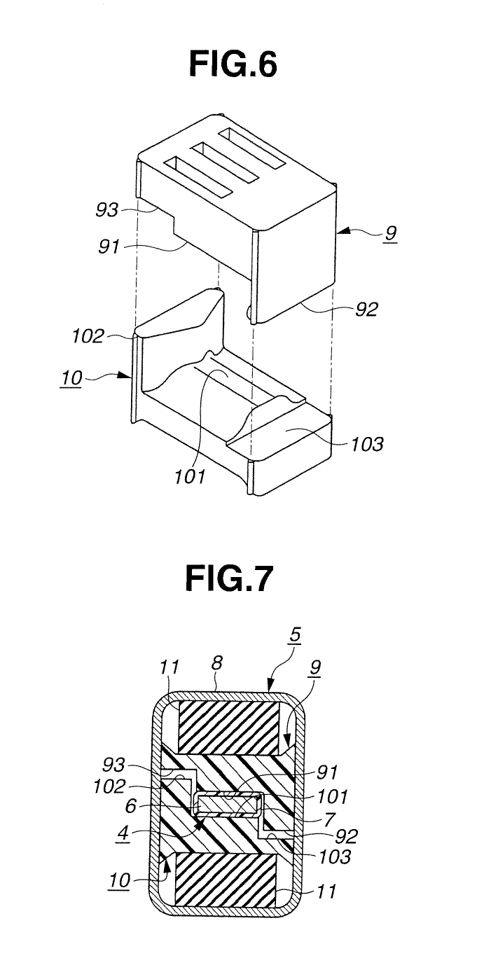

As will be understood from FIGS. 6 and 7, the upper and lower press shoes 9 and 10 are arranged in the case 8 to put therebetween the check link 4 while showing a point symmetry therebetween.

The upper press shoe 9 comprises the projected sliding portion 91 that slides on the upper surface of the check link 4, a guide wall 92 that projects downward from a right side part (in FIG. 7) of the projected sliding portion 91 and slidably contacts with a right side edge of the check link 4 and a guide groove 93 that is depressed from a left side part (in FIG. 7) of the projected sliding portion 91.

As will be mentioned hereinafter, the guide wall 92 is received in a guide groove 103 of the lower press shoe 10 and the guide groove 93 receives therein a guide wall 102 of the lower press shoe 10.

As is seen from FIG. 7, a right side surface of the guide wall 92 slidably contacts with an inner surface of a right wall of the case 8, and a left side surface of a bottom portion of the guide groove 93 slidably contacts with an inner surface of a left wall of the case 8. With this arrangement, the upper press shoe 9 is suppressed from undesired inclination in the case 8 during its upward and downward movement. That is, the upper press shoe 9 can move upward and downward in a smoothed manner.

As will be understood from FIGS. 6 and 11, an inner surface of the guide wall 92 is shaped like a roof having a ridge that slidably contacts with both the right side edge of the check link 4 and the right side surface of the projected sliding portion 101 of the lower press shoe 10.

The lower press shoe 10 comprises the projected sliding portion 101 that slides on the lower surface of the check link 4, a guide wall 102 that projects upward from a left side part (in FIG. 7) of the projected sliding portion 101 and slidably contacts with a left side edge of the check link 4 and a guide groove 103 that is depressed from a right side part (in FIG. 7) of the projected sliding portion 101.

As is seen from FIG. 7, a left side surface of the guide wall 102 slidably contacts with an inner surface of a left wall of the case 8, and a right side surface of a bottom portion of the guide groove 103 slidably contacts with an inner surface of a right wall of the case 8. With this arrangement, the lower press shoe 10 is suppressed from undesired inclination in the case 8 during its upward and downward movement. That is, like the above-mentioned upper press shoe 9, the lower press shoe 10 can move upward and downward in a smoothed manner.

As will be understood from FIGS. 6 and 11, an inner surface of the guide wall 102 is shaped like a roof having a ridge that slidably contacts with both the left side edge of the check link 4 and the left side surface of the projected sliding portion 91 of the upper press shoe 9.

As is seen from FIG. 7, the upper elastic body 11 is disposed between an upper wall of the case 8 and an upper surface of the upper press shoe 9 in a manner to bias the upper press shoe 9 toward the check link 4, and the lower elastic body 11 is disposed between a lower wall of the case 8 and a lower surface of the lower press shoe 10 in a manner to bias the lower press shoe 10 toward the check link 4.

When it is intended to install the door checker unit 1 to an associated motor vehicle, the following steps are carried out.

First, the check box 5 is secured to the front end wall of the vehicle door D in the above-mentioned manner.

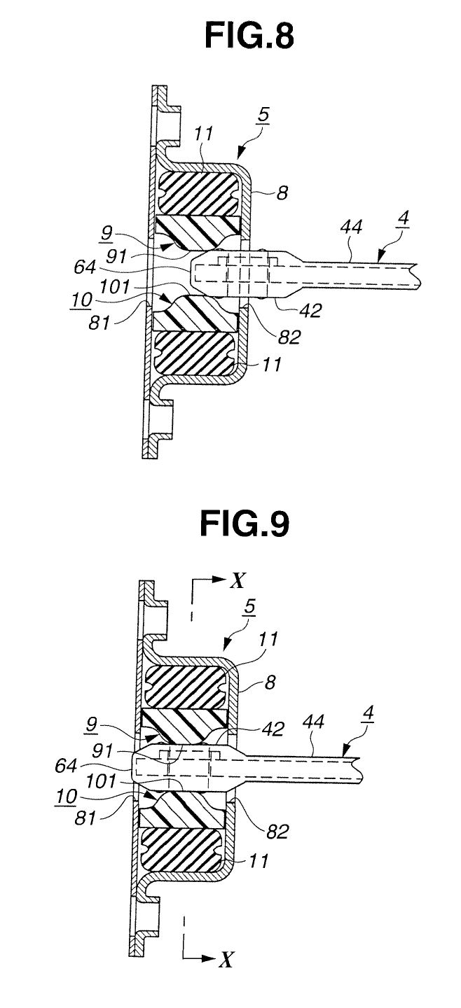

Then, as is seen from FIG. 8, the check link 4 is brought to the check box 5 bringing and guiding the tapered end 64 thereof into the opening 82 of the check box 5.

Then, as is seen from FIG. 9, the check link 4 is pushed forward, that is in a leftward direction in FIG. 9, causing the perforated boss portion 42 of the check link 4 to push the upper and lower press shoes 9 and 10 upward and downward respectively against the biasing force of the upper and lower elastic bodies 11.

Due to provision of the tapered end 64 of the perforated boss portion 42 and above-mentioned dimensional relation between various parts of the check link 4, insertion of the perforated boss portion 42 between the upper and lower press shoes 9 and 10 is easily and smoothly carried out.

Although not shown in the drawings, the leftward pushing work is continued until the perforated boss portion 42 comes out of the check box 5 through the guide opening 81. Upon this, the perforated boss portion 42 is projected outward from the guide opening 81 of the door D and the upper and lower press shoes 9 and 10 come to a position to put therebetween a thin flat portion 44 of the check link 4 that is provided between the perforated to boss portion 42 and the detent surface portion 41.

Then, the perforated boss portion 42 projected from the guide opening 81 of the door D is brought to connect to the body fixed bracket 2 by means of the pivot pin 3, as will be understood from FIG. 1.

In the following, operation of the door checker unit 1 will be described with reference to the drawings.

When the vehicle door D is in the full-close position as is shown by a solid line in FIG. 2, the door checker unit 1 assumes a rest condition as shown in FIG. 3.

Under the rest condition, the upper and lower press shoes 9 and 10 put therebetween the thin flat portion 44 of the check link 4 permitting a little free movement of the check link 4 therebetween. Thus, in this case, the door checker unit 1 does not exhibit a door checking function. However, actually, in such case, the door checking function is not needed because a door latch mechanism (not shown) is operating to latch the vehicle door D.

When the vehicle door D is unlatched and swung to a half-open position, the upper and lower press shoes 9 and 10 in the check box 5 are brought to one of the depressed portions 412 of the check link 4 as is shown by a dot-dash line in FIG. 4. Upon this, the two press shoes 9 and 10 tightly hold the check link 4 at the selected depressed portion 412 with the aid of the biasing force of the elastic bodies 11. Under this condition, the vehicle door D is retained at the selected half-open position.

When then the vehicle door D is further swung outward to its full-open position as is shown in a dot-dash line in FIG. 2, the two press shoes 9 and 10 are brought onto the neck portion 413 of the head-like stopper 53 of the check link 4 as is shown by a solid line in FIG. 4. In this case, the case 8 of the check box 5 abuts against the head-like stopper 43 and thus, further opening swing of the vehicle door D is suppressed.

In the following, the guide walls 92 and 102 of the upper and lower press shoes 9 and 10 will be described in detail.

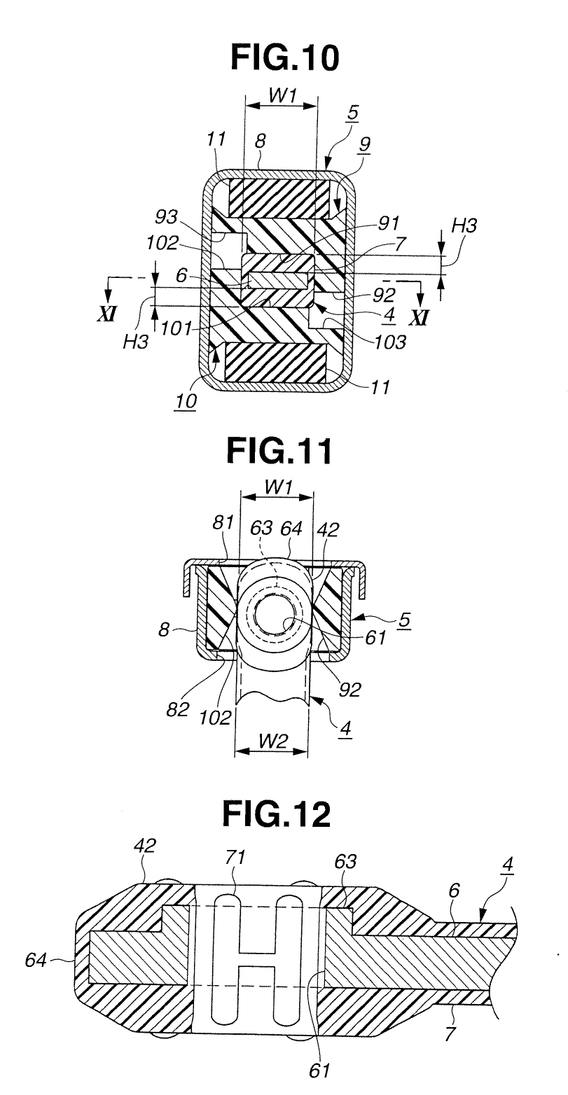

(1) As is seen from FIG. 10, the height of the guide wall 92 of the upper press shoe 9 is greater than a thickness H3 of an upper plastic cover 7 at the perforated boss portion 42, and the height of the guide wall 102 of the lower press shoe 10 is also greater than the thickness H3 of a lower plastic cover 7 at the perforated boss portion 42. The thickness H3 of the upper or lower plastic cover 7 at the perforated boss portion 42 will be well understood from FIG. 5.

With such dimensional relation between the height of the guide wall 92 or 102 and the thickness H3 of the upper or lower plastic cover 7 of the check link 4, insertion of the perforated boss portion 42 of the check link 4 between the two press shoes 9 and 10 is easily made.

That is, in the door checker unit 1 of the first embodiment of the invention, the lateral size W1 of the perforated boss portion 42 is substantially the same as the lateral size W2 of the detent surface portion 41 of the plastic cover 7 and a contacting zone of each of the guide walls 92 and 102 of the upper and lower press shoes 9 and 10 against a side surface of the perforated boss portion 42 is increased in a vertical direction as compared with that of the above-mentioned known door checker. Thus, as will be understood from FIG. 10, a distance between a front end surface of the guide wall 92 and the projected sliding portion 101 and that between a front end surface of the guide wall 102 and the projected sliding portion 91 are both educed, and thus, when being put between the two press shoes 9 and 10, the perforated boss portion 42 of the check link 4 is permitted to take an assured or reliable pass way. This means that insertion of the perforated boss portion 42 between the two press shoes 9 and 10 is easily and smoothly achieved by the manual work.

Furthermore, since the height of each guide wall 92 or 102 is greater than the thickness H3 of the upper or lower plastic cover 7 at the perforated boss portion 42, the upper or lower plastic cover 7 is suppressed from being scraped from upper or lower surface of the metal plate 6 even when the check link 4 is strongly pressed in a lateral direction by the guide walls 92 and 102 of the two press shoes 9 and 10.

(2) When, as is shown in FIG. 3, the vehicle door D takes its full-close position, that is, when the two press shoes 9 and 10 of the check box 5 hold the thin flat portion 44 of the check link 4, the two press shoes 9 and 10 and the thin flat portion 44 take their positions as shown in FIG. 7. That is, in this condition, the guide wall 92 of the upper press shoe 9 projects downward into the guide groove 103 of the lower press shoe 10 beyond the lower surface of the thin flat portion 44 of the check link 4, and at the same time, the guide wall 102 of the lower press shoe 10 projects upward into the guide groove 93 of the upper press shoe 9 beyond the upper surface of the thin flat portion 44 of the check link 4. It is to be noted that under such condition, the guide wall 92 of the upper press shoe 9 slidably contacts with the right side surface of the thin flat portion 44 of the check link 4 and at the same time, the guide wall 102 of the lower press shoe 10 slidably contacts with the left side surface of the thin flat portion 44 of the check link 4. Thus, displacements in lateral direction of the check link 4 are suppressed without inducing interference between the two press shoes 9 and 10.

Furthermore, the right side surface of the guide wall 92 of the upper press shoe 9 slidably contacts with the inner surface of the right wall of the case 8 and the bottom portion of the guide groove 93 of the upper press shoe 9 slidably contacts with the inner surface of the left wall of the case 8, and at the same time, the left side surface of the guide wall 102 of the lower press shoe 10 slidably contacts the inner surface of the left wall of the case 8 and the bottom wall of the guide groove 103 of the lower press shoe 10 slidably contacts with the inner wall of the right wall of the case 8. With this arrangement, the upper and lower press shoes 9 and 10 are suppressed from undesired inclination in the case 8 during their upward and downward movement.

Thus, when the vehicle door D is in its full-close position, the upper and lower press shoes 9 and 10 can assuredly and stably hold the check link 4. Accordingly, even under running of the associated motor vehicle, undesired noise, what would be caused by vibration of the check link 4, is not produced.

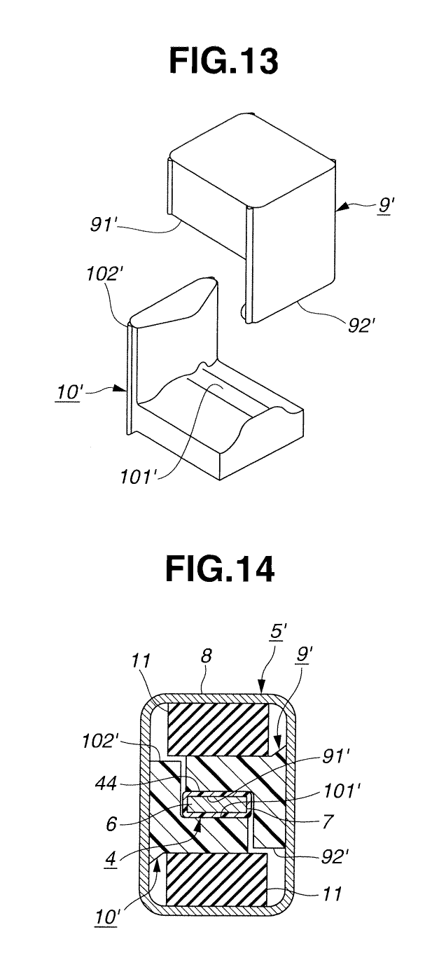

Referring to FIGS. 13, 14 and 15, there is shown a door checker unit of a second embodiment of the present invention.

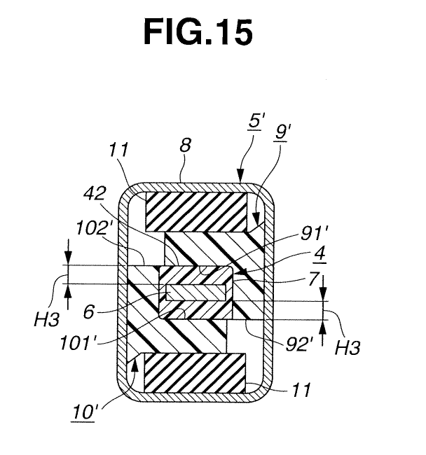

More specifically, FIG. 13 shows paired press shoes used in a check box used in the second embodiment of the present invention, FIG. 14 is a view similar to FIG. 7, but showing the check box used in the second embodiment and FIG. 15 is a view similar to FIG. 10, but showing the check box used in the second embodiment.

As will be well understood when comparing FIG. 13 with FIG. 6, in the second embodiment, upper and lower press shoes 9′ and 10′ of a check box 5′ have no means that correspond to the guide grooves 93 and 103 of the upper and lower press shoes 9 and 10 employed in the above-mentioned first embodiment.

That is, in the second embodiment, the upper and lower press shoes 9′ and 10′ have only guide walls 92′ and 102′, and as is seen from FIGS. 14 and 15, the upper and lower press shoes 9′ and 10′ are arranged in the case 8 to put therebetween the check link 4 while showing a point symmetry therebetween.

As is seen from FIG. 14, when the two press shoes 9′ and 10′ are in a position to hold the think flat portion 44 of the check link 4, the guide wall 92′ of the upper press shoe 9′ slidably contacts with both a right side edge of the check link 4 and a right side surface of the lower press shoe 10′ and the guide wall 102′ of the lower press shoe 10′ slidably contacts with both a left side edge of the check link 4 and a left side surface of the upper press shoe 9′.

As is seen from FIG. 15, the height of the guide wall 92′ of the upper press shoe 9′ is greater than the thickness H3 of the upper plastic cover 7 at the perforated boss portion 42, and the height of the guide wall 102′ of the lower press shoe 10′ is also greater than the thickness H3 of the lower plastic cover 7 at the perforated boss portion 42.

With such dimensional relation between the height wall 92′ or 102′ and the thickness H3 of the upper or lower plastic cover 7 of the check link 4, insertion of the perforated boss portion 42 of the check link 4 between the two press shoes 9′ and 10′ can be easily made. In the second embodiment, due to inherent construction of the upper and lower press shoes 9′ and 10′, the projection degree of the guide walls 92′ and 102′ is high as compared with that of the guide walls 92 and 102 of the first embodiment, which promotes the assured guiding to the check link 4 when the perforated boss portion 42 of the check link 4 is put into the clearance between the upper and lower press shoes 9′ and 10′.

The entire contents of Japanese Patent Application 2011-059237 filed Mar. 17, 2011 are incorporated herein by reference.

Although the invention has been described above with reference to the embodiments of the invention, the invention is not limited to such embodiments as described above. Various modifications and variations of such embodiments may be carried out by those skilled in the art, in light of the above description.

What is claimed is:

1. A door checker unit of a motor vehicle, comprising:
a check link including a base end adapted to be connected to one of a vehicle body and a vehicle door, an elongate portion that extends from the base end and is formed with a waved detent portion and a head-like stopper that is integrally formed on a leading end of the elongate portion; and
a check box adapted to be connected to the other one of the vehicle body and the vehicle door, the check box including upper and lower press shoes for putting therebetween the check link in a vertical direction and biasing members for biasing the upper and lower press shoes toward the check link, each of the upper and lower press shoes being formed with a projected guide wall,
wherein the waved detent portion of the check link consists of upper and lower waved detent surfaces provided on the check link
wherein the guide walls of the upper and lower press shoes put therebetween the check link in a lateral direction; and
wherein a width of the base end of the check link is substantially the same as that of the waved detent portion of the check link.

2. A door checker unit of a motor vehicle, comprising:
a case adapted to connect to a door and having an opening formed therethrough;
a check link having a base end adapted to connect to a vehicle body and extending through the opening of the case to an end thereof where a head-like stopper is integrally formed;
upper and lower press shoes movably installed in the case in a manner to put therebetween the check link; and
upper and lower biasing members installed in the case in a manner to bias the upper and lower press shoes toward the check link,
wherein the check link comprises an elongate metal plate and a molded plastic cover that covers the metal plate to constitute upper and lower waved detent surfaces of the molded plastic on the metal plate, the base end of the check link having a boss portion whose width is substantially the same as a width of the check link at a portion where the upper and lower waved detent surfaces are provided, and a thickness of the boss portion being larger than that of the check link at a portion placed between the boss portion and each of the upper and lower waved detent surfaces, and
wherein each of the upper and lower press shoes is formed with a projected sliding portion that faces an upper or lower surface of the check link and a guide wall that projects downward or upward from one end of the projected sliding portion, and
wherein the upper and lower press shoes are so arranged that the projected sliding portions of the press shoes slidably put therebetween the check link in a vertical direction and the guide walls slidably put therebetween the check link in a lateral direction.

3. A door checker unit as claimed in claim 2, in which the upper and lower press shoes are arranged in the case in a manner to show a point symmetry therebetween.

4. A door checker unit as claimed in claim 3, in which the guide wall of one of the press shoes is sized to have an inner surface that slidably contacts with a lateral end surface of the projected sliding portion of the other press shoe.

5. A door checker unit as claimed in claim 4, in which the inner surface of each of the guide walls of the press shoes is shaped like a roof having a ridge that slidably contacts with both a lateral edge portion of the check link and the lateral end surface of the corresponding projected sliding portion.

6. A door checker unit as claimed in claim 2, in which each of the upper and lower press shoes is further formed with a guide groove depressed from a lateral side end that is opposite to the side end where the guide wall is provided, the guide groove being arranged to slidably receive therein the guide wall of the partner's shoe.

7. A door checker unit as claimed in claim 2, in which the height of the guide wall is greater than a thickness of the plastic to cover of the check link at a portion where the boss portion is provided.

8. A door checker unit of a motor vehicle, comprising:
a case adapted to connect to a door and having an opening formed therethrough;
a check link having a base end adapted to connect to a vehicle body and extending through the opening of the case to a leading end thereof where a head-like stopper is integrally formed;
upper and lower press shoes movably installed in the case in a manner to put therebetween the check link; and
upper and lower biasing members installed in the case in a manner to bias the upper and lower press shoes toward the check link,
wherein the check link comprises an elongate metal plate and a molded plastic cover that covers the metal plate to constitute upper and lower waved detent surfaces of the molded plastic on the metal plate, the base end of the check link having a thicker boss portion whose width is substantially the same as a width of the check link at a portion where the upper and lower waved detent surfaces are provided, and a thickness of the thicker boss portion being greater than that of the check link at a portion placed between the boss portion and each of the upper and lower waved detent surfaces, and
wherein each of the upper and lower press shoes is formed with a projected sliding portion that faces an upper or lower surface of the check link, a guide wall that projects downward or upward from one end of the projected sliding portion and a guide groove that is depressed from the other end of the projected sliding portion, and
wherein the upper and lower press shoes are so arranged that the projected sliding portions of the press shoes slidably put therebetween the check link in a vertical direction, the guide walls slidably put therebetween the check link in a lateral direction and slidably put in the guide grooves of each partner's shoe.

9. A door checker unit as claimed in claim 8, in which the upper and lower press shoes are arranged in the case in a manner to show a point symmetry therebetween.
